(19) United States
(12) Patent Application Publication
(10) Pub. No.: US 2012/0163908 A1
(43) Pub. Date: Jun. 28, 2012

(54) BUTTON FIXING STRUCTURE

(75) Inventors: WEI ZENG, Shenzhen City (CN); ZHONG-JIE LUO, Shenzhen City (CN); JIAN-HUI DAI, Shenzhen City (CN); BING-YANG LI, Shenzhen City (CN); YU-TAO CHEN, Tu-Cheng (TW); TE-SHENG JAN, Tu-Cheng (TW); CHUN-CHE YEN, Tu-Cheng (TW)

(73) Assignees: HON HAI PRECISION INDUSTRY CO.,LTD., Tu-Cheng (TW); HONG FU JIN PRECISION INDUSTRY (ShenZhen) CO.,LTD., Shenzhen City (CN)

(21) Appl. No.: 13/178,522

(22) Filed: Jul. 8, 2011

(30) Foreign Application Priority Data
Dec. 28, 2010 (CN) 201010609176.9

(51) Int. Cl. G05G 1/02; F16B 17/00

(52) U.S. Cl. 403/376

(57) ABSTRACT

A button fixing structure which includes a shell and a button fixed to the shell. The shell includes a groove and includes two opposite elastic holding portions adjacent to the groove. A deformable fixing hole is formed between the two holding portions. The button includes a base plate and a first fixing portion perpendicularly protruding from the base plate. The first fixing portion is an interference fit in the deformable fixing hole and is held in position by and between the holding portions.

### BACKGROUND

1. Technical Field

The present disclosure relates to a button fixing structure.

2. Description of Related Art

Buttons are applied in many electronic devices for actuating switches. A button is generally received in a hole defined in the electronic device. The button usually has a clearance fit in the hole. Thus, a gap exists between the button and the hole, which reduces haptic feedback.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a button fixing structure according to an exemplary embodiment.

FIG. 2 is a partial, exploded view of the button fixing structure in FIG. 1.

FIG. 3 is an isometric view of the button in FIG. 2, but viewed from another aspect.

FIG. 4 is a partial isometric view of the button fixing structure in FIG. 1, but viewed from still another aspect.

FIG. 5 is similar to FIG. 4, but viewed from yet another aspect.

### DETAILED DESCRIPTION

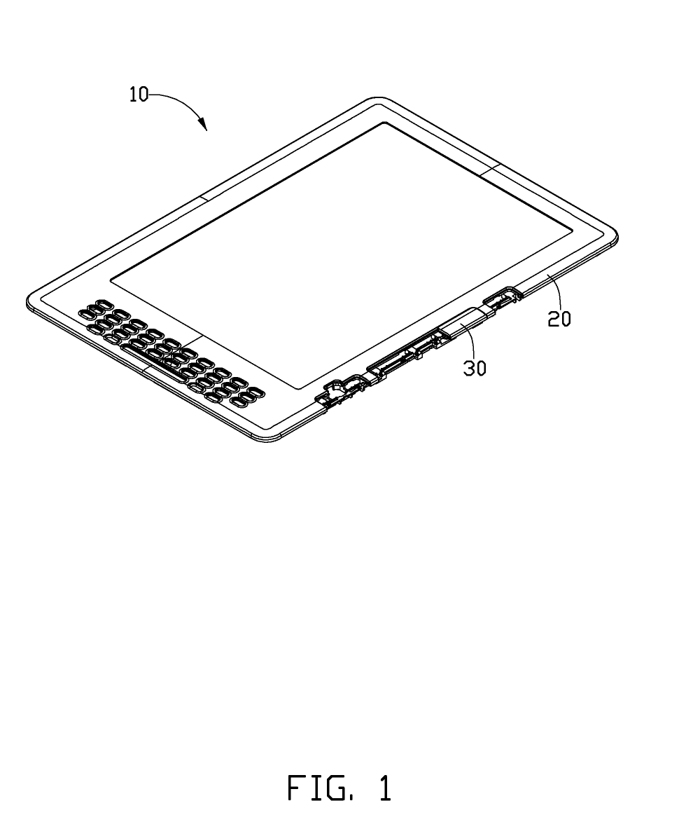

Referring to FIG. 1, an electronic device including a button fixing structure 10 according to an exemplary embodiment is shown. The button fixing structure 10 includes a shell 20 and a button 30 fixed to the shell 20. The top of the button 30 is flush with the top of the shell 20.

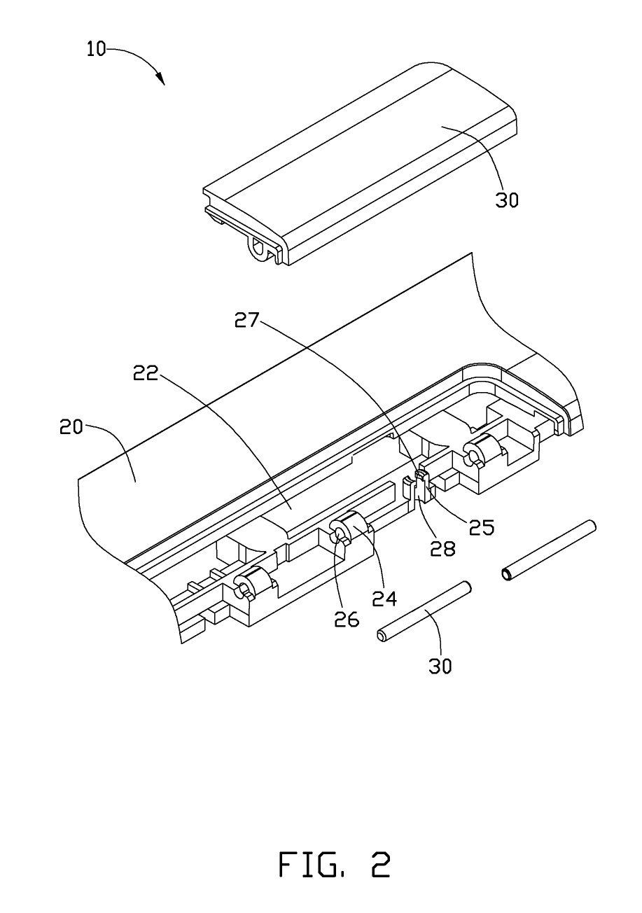

Referring to FIG. 2, the shell 20 defines a groove 22 for receiving the button 30. The shell 20 is formed with two restriction portions 24 below the groove 22. The restriction portions 24 are under the button 30. Each restriction portion 24 defines a transverse hole 26. The central axis of the transverse hole 26 is parallel to the plane of the upper surface of the shell 20. The shell 20 further includes two opposite elastic holding portions 25 below the groove 22. The holding portions 25 are spaced so as to form a fixing hole 28 between them. The central axis of the fixing hole 28 is perpendicular to the plane of the upper surface of the shell 20. Each holding portion 25 includes a hooked end, the top corners of the hooked ends being beveled inwards (inclined surface 27) so as to define a section of a cone between the tops of the holding portion 25. In the exemplary embodiment, the shell may be made of plastic. The holding portions 25 can be integrally formed in the shell 20 by molding.

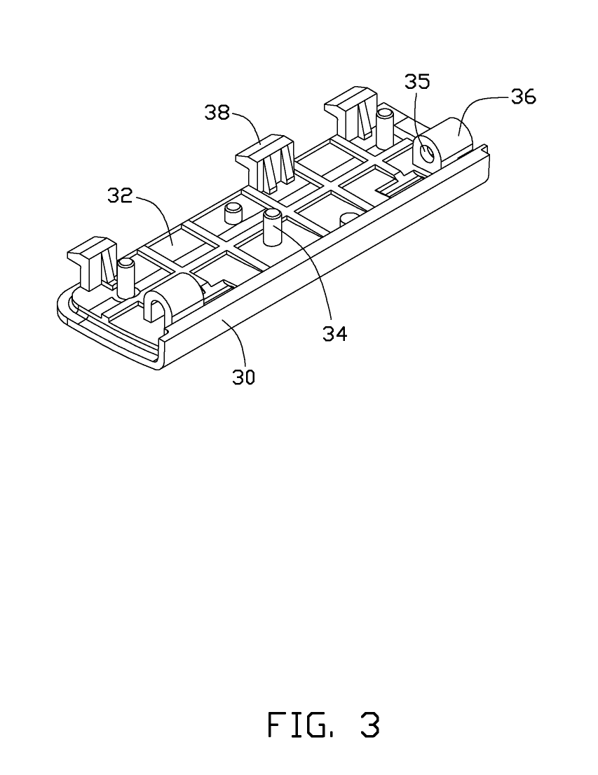

Referring to FIG. 3, the button 30 includes a base plate 32, a first fixing portion 34, a second fixing portion 36 and a third fixing portion 38. The first fixing portion 34, the second fixing portion 36 and the third fixing portion 38 protrude perpendicularly from the base plate 32.

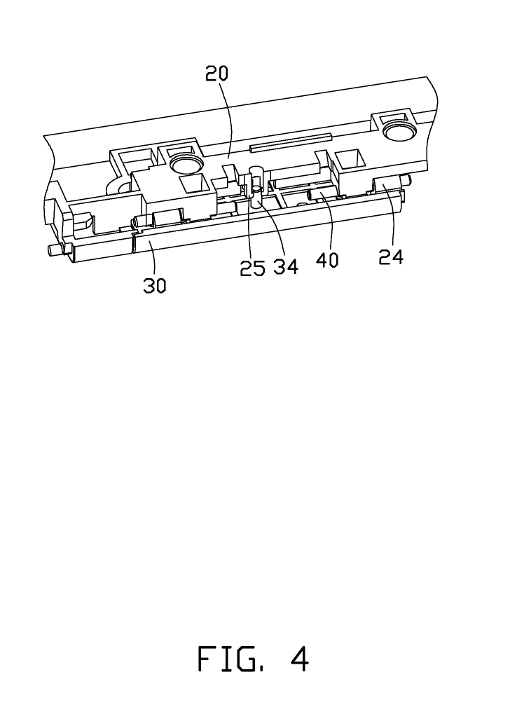

Referring to FIGS. 3 and 4, the first fixing portion 34 is held in position by means of the clamping action of the two holding portions 25. The first fixing portion 34 is an interference fit in the fixing hole 28. In this way, after being pressed many times, the button 30 can still engage with the two holding portions 25, thereby providing excellent haptic feedback to a user. The inclined surface 27 allows the first fixing portion 34 some lateral movement, which would simply cause the holding portions 25 to be further deformed. Thus the first fixing 34 can maintain firm contact with the two holding portions 25 when the button 30 is depressed. In the exemplary embodiment, the first fixing portion 34 is a cylindrical post.

The second fixing portion 36 defines a through hole 35 aligned with the transverse hole 26 of the shell 20. A rod 40 extends through the transverse hole 26 and the through hole 35. The rod 40 is a press fit in the transverse hole 26 and a clearance fit in the through hole 35, thus the button 30 can move along the rod 40. In the exemplary embodiment, the button 30 includes two second fixing portions 36 respectively arranged at two opposite sides of the first fixing portion 34.

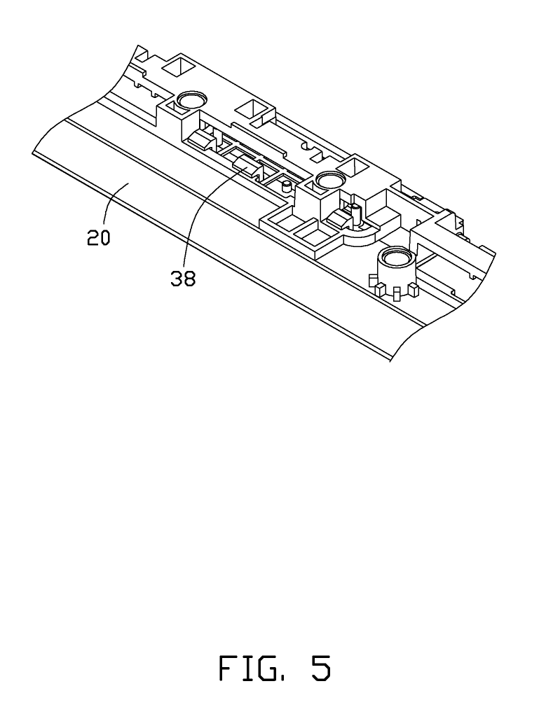

Referring to FIGS. 3 and 5, at least one third fixing portion 38 is positioned at an edge of the base plate 32. The third fixing portion 38 includes a hook end 37. The hook end 37 hooks onto the base of the shell 20 to prevent the button 30 from rotating excessively about the rod 40, and maintains the position of the button 30 relative to the shell 20. In the exemplary embodiment, there are three third fixing portions 38 arranged lengthwise along the base plate 32.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A button fixing structure comprising:
a shell; and
a button fixed to the shell;
wherein the shell comprises a groove and comprises two opposite elastic holding portions adjacent to the groove, a deformable fixing hole is formed between the two holding portions, the button comprises a base plate and a first fixing portion perpendicularly protruding from the base plate, the first fixing portion is an interference fit in the fixing hole and is held in position by and between the holding portions.

2. The button fixing structure of claim 1, wherein the shell is a unitary piece with the holding portions integrally formed thereon.

3. The button fixing structure of claim 1, wherein the holding portions include inwardly inclined surface at distal ends thereof, the first fixing portion is configured to move along the inclined surfaces thus deforming the holding portions, thereby the first fixing portion coming into firm contact with the holding portions.

4. The button fixing structure of claim 1, wherein the shell includes a restriction portion adjacent to the groove, the restriction portion is covered by the button and defines a hole, the central axis of the hole is substantially parallel to a main plane of the button, the button comprises a second fixing portion defining a through hole aligned with the hole, a rod extends through the hole and the through hole, the rod is a press fit in the hole and a clearance fit in the through hole.

5. The button fixing structure of claim 1, wherein the button includes a third fixing portion at an edge of the base plate, the third fixing portion is fixedly engaged with the shell.

6. The button fixing structure of claim 1, wherein the first fixing portion is a cylindrical post.
